(19) United States
(12) Patent Application Publication
(10) Pub. No.: US 2016/0195486 A1
(43) Pub. Date: Jul. 7, 2016

(54) Method and Apparatus for Detection, Identification and Quantification of Chemical or Biological Material through Modification of Operating Conditions

(71) Applicants: Mahmood Anvar, Cupertino, CA (US); Louis Wong, Los Altos Hills, CA (US)

(72) Inventors: Mahmood Anvar, Cupertino, CA (US); Louis Wong, Los Altos Hills, CA (US)

(21) Appl. No.: 14/590,950

(22) Filed: Jan. 6, 2015

(51) Int. Cl. G01N 27/04; G01N 27/12

(52) U.S. Cl. CPC G01N 27/046; G01N 27/12

(57) ABSTRACT

A sensors reading when exposed to different chemical compounds changes if an operating condition of the sensor such as temperature, pressure, electromagnetic field intensity, light or radiation level is modified and the amount of change is different for different compounds. This invention uses this phenomenon to identify and quantify the concentration of the compound.

### BACKGROUND

Sensors for different material work based on reaction between the sensing element and the material to be sensed. The detection technology is based on the changing physical properties of different sensor material when exposed to different chemicals. These physical properties include bulk volume, resistivity, capacitance, optical properties, color, ultraviolet/light/infra-red absorption or transmission spectrum, or any other property which is detectable through measurements. Many sensors respond to, and can detect more than a single substance. This is referred to as “cross sensitivity”. Cross sensitivity is often considered a hindrance as it diminishes the specificity of the sensor. Since the level of effect of exposure of the sensor to different chemicals is first dependent on the type of chemical and second, on the concentration of the chemical, in order to distinguish between different chemicals, it becomes necessary to use arrays of sensors made of different sensing elements. In this manner, since each sensor reacts differently when exposed to set of, chemicals, the collection of readings from these sensors makes a unique signature for each chemical. As long as a one to one correspondence between this signature and a chemical can be established, the chemical can he identified and its concentration can be quantified. In other words, multiple sensors, each especially sensitive to a specific class of compounds, are used together as a sensor array. The collective response of a sensor array provides a “fingerprint,” or characteristic pattern, that distinguishes one chemical compound from another. Sensor arrays with polymer coatings are often called “electronic noses” because they recognize response patterns from multiple sensors, just as mammalian noses recognize response patterns from several olfactory receptors.

How does a typical sensor work?

The chemiresistor is a small, simple, sensitive, rugged microsensor with low power requirements capable of detecting chemical vapors in air or gases, soil, water or liquids. Chemical detection with the chemiresistor is possible through thin electrically-conductive polymer films that swell in the presence of volatile organic chemicals in the vapor phase; chemical concentration is indicated by the degree of swelling as measured through a change in electrical resistance across the film. Because the swelling of the polymer is reversible, the chemiresistor resets when the chemical disappears from the environment. Therefore, it can be used repeatedly without component replacement. An array of this miniature, low power devices has been used to detect multiple chemical contaminants. The chemiresistor requires simple circuitry to read electrical resistance. Other types of polymeric sensors also work based on principles similar to absorption of water by foam. Therefore, depending on the amount of chemical absorbed into the structure of the polymer, previously mentioned physical properties such as capacitance or color, etc., changes and it gets detected through appropriate means. Other types of sensors also work in a very similar manner and only differ in the change in observed physical property.

### BRIEF SUMMARY OF THE INVENTION

Response of sensors exposed to chemicals when measured under different operating conditions such as different temperatures, atmospheric pressures, humidity levels or exposure to different electric field, magnetic field or electromagnetic radiation varies as the operating condition is changed. The sensitivity of sensors to different operating conditions however, is not the same when exposed to different chemicals. We use this effect to identify the chemical. More than one reading is made from the sensor under different operating conditions. These readings are compared against a database of measurements for a matching pattern, or sensitivity of reading to operating condition change is calculated mathematically, to identify the chemical compound and its concentration. Alternatively, an array of similar sensors where each one operates at a different condition is simultaneously exposed to the chemical compound to be identified and the responses are compared to the database to identify the chemical compound.

### BRIEF DESCRIPTION OF THE DRAWINGS

FIG. 1 the variation in the response of a sensor when temperature changes for two different chemicals. The temperature sensitivity is higher for chemical 2 than for chemical 1

FIG. 2 shows basic structure for a chemical sensor

FIG. 3 shows another basic sensor

FIG. 4 depicts the basic electrical setup for measuring the response of a single sensor to presence of a chemical compound.

FIG. 5 shows one embodiment of controlling the operating condition for the sensor

FIG. 6 illustrates an array of similar sensors each one operating in a different condition.

FIG. 7 depicts a self-heating sensor setup.

FIG. 8 depicts an array of self-heating similar sensors.

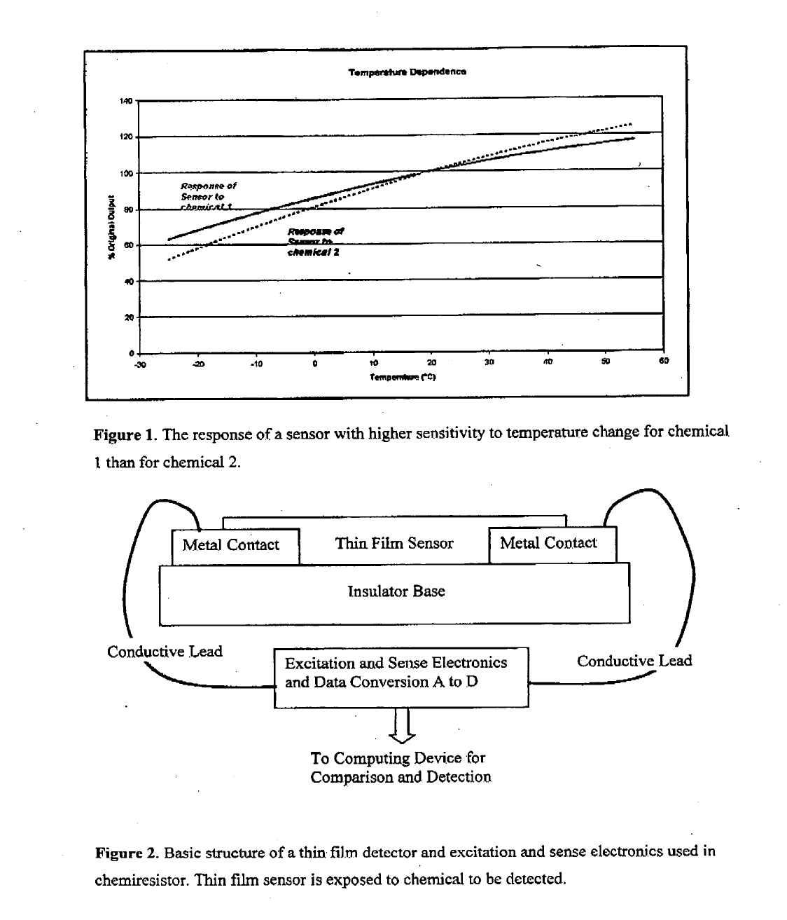

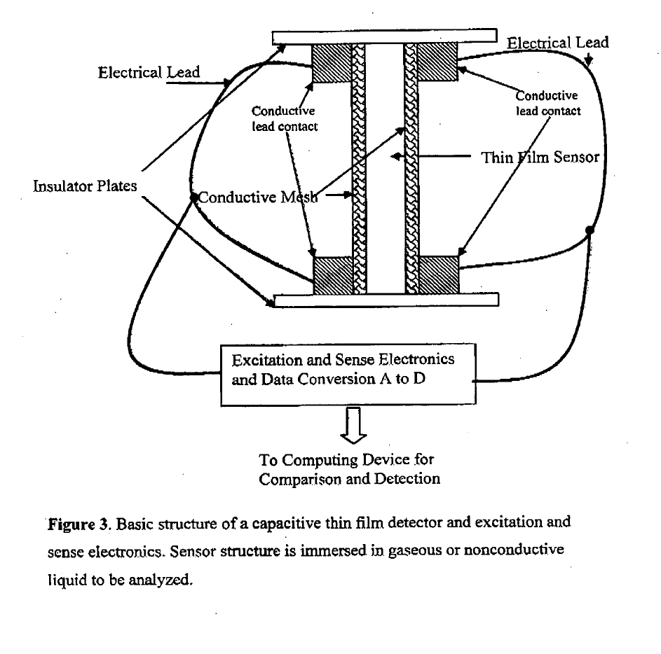

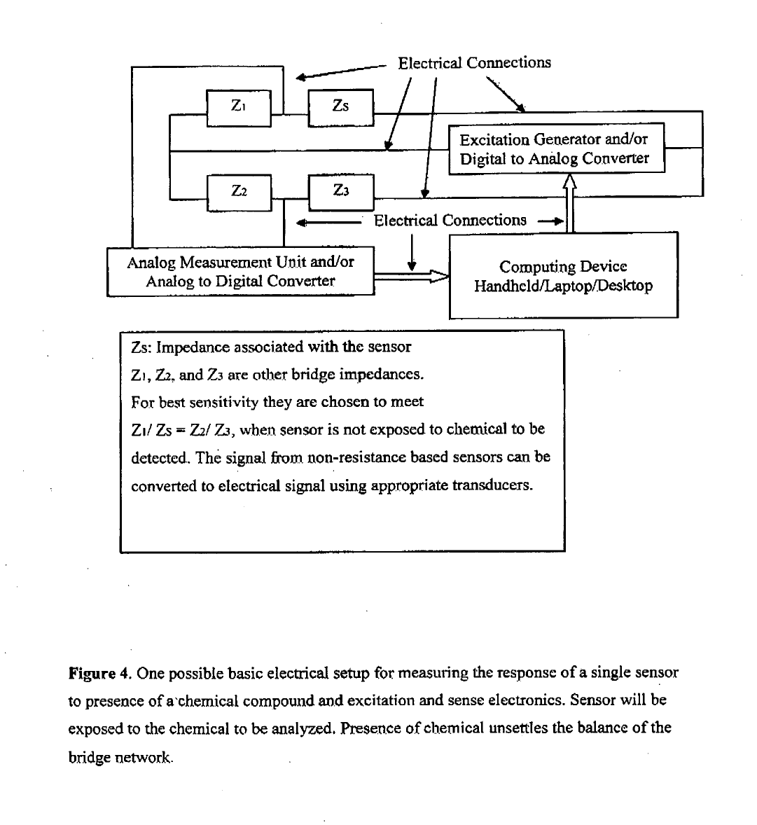

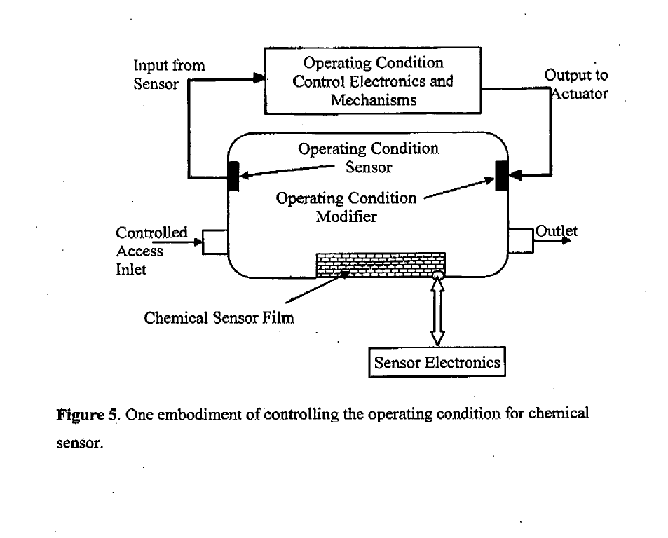

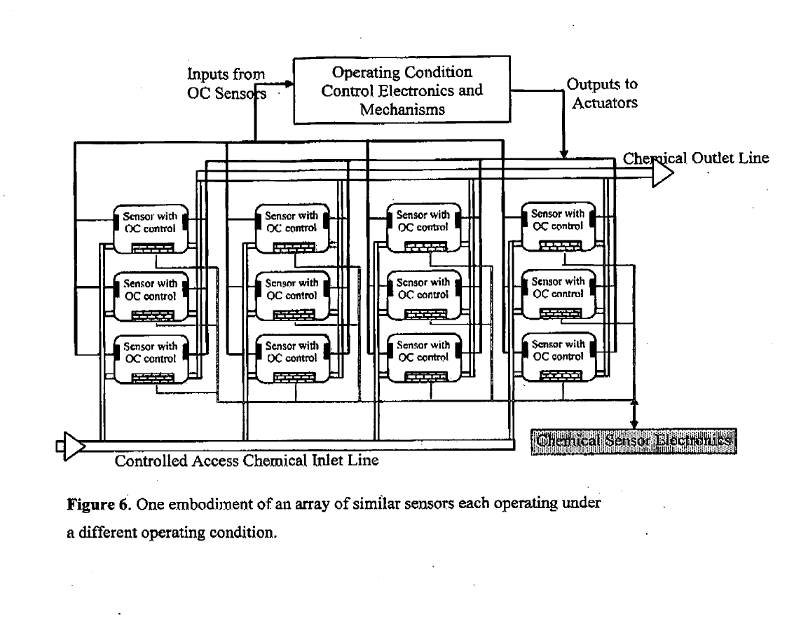

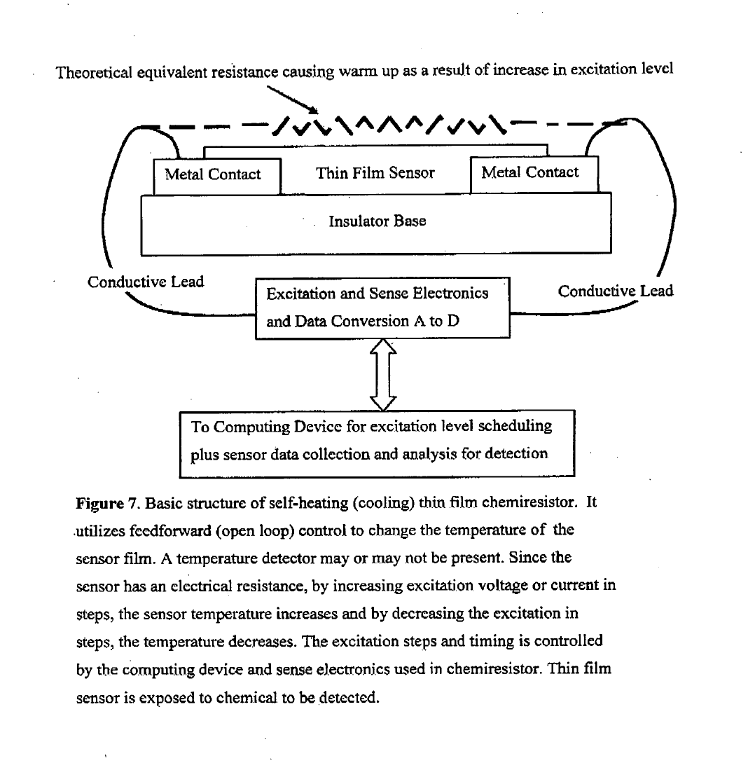

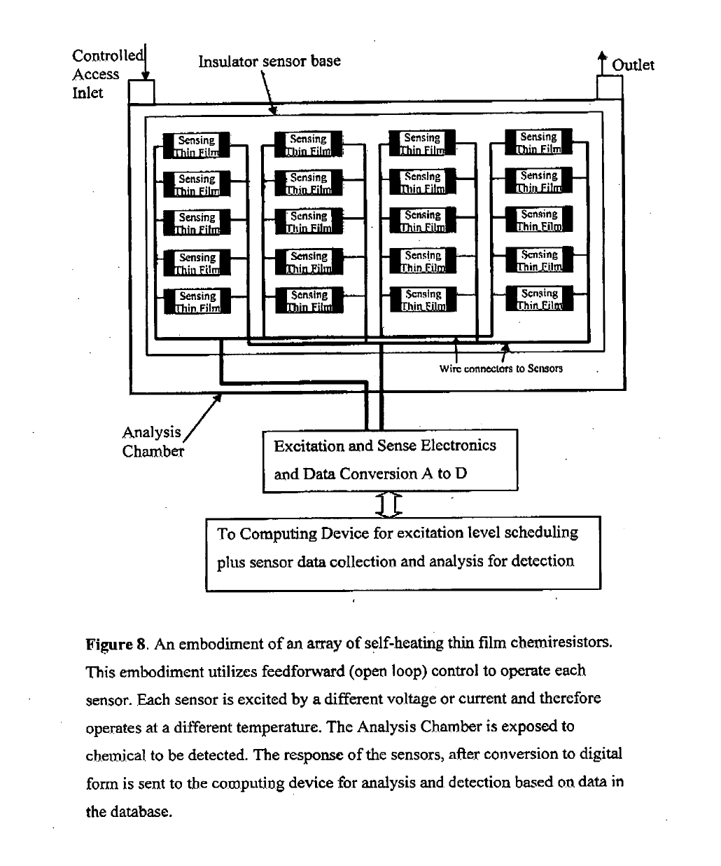

### DETAILED DESCRIPTION AND IMPLEMENTATION

In one embodiment, the sensor is encased in an appropriately sized container with an appropriate temperature control mechanism including heating/cooling elements, temperature sensor, and necessary feedback/feedforward control mechanisms. In this manner, the chemical sensor is brought up and maintained at the desired temperature. Then the chemical compound to be identified is introduced to the container and the response of the sensor is measured and stored/recorded. In the next step, the temperature of the container is set to a different value and measurement repeated and data recorded. This procedure is repeated at as many different temperatures as desired as long as the setup is capable of safely handling. Since different chemicals at different temperatures and different concentrations produce different readings, this collected set of data is compared to a database containing responses of the particular sensor used in the device to chemicals of interest. A matching pattern identifies the presence of the matched chemical and its level of concentration. It should be noted that it is possible but not necessary, to flush the container using an inert compound before making a new measurement at a new temperature. However, since the chemical compound to be identified is at a different temperature, the readings have to be compared to a database compiled using a similar procedure for accuracy.

Another embodiment of this invention is using self heating procedure. For example, when using a chemiresistor, a voltage is applied to the sensor and the current is measured to monitor the resistance which changes as the result of the exposure to chemical compounds. By modifying the applied voltage, or duration of voltage application, the sensor will dissipate a different amount of power and as such it will have a different temperature at each voltage level. The simplicity of this embodiment makes it particularly economical to implement.

Another embodiment is using an array of sensors made of the same material but each one placed in a different container that is maintained at a different operating condition. All the containers and sensors can simultaneously or sequentially be exposed to the compound to be analyzed and responses collected. This depends on whether each sensor has a dedicated measurement circuit or the measurement circuit is shared between the sensors.

Another embodiment uses varying the pressure inside the sensor container or in case of an array of sensors, operating each one at a different pressure.

Another embodiment changes the intensity and wavelength of incident electric field, magnetic field, electromagnetic or light on the sensor(s) before or during the exposure to the chemical compound to be analyzed. In all cases, as long as the measured data is compared to a database that has been compiled in the same manner, the results are accurate.

Also, modification of multiple operating conditions produces more data points and enhances the possibility of detecting and accuracy of reading of the chemical compound to be analyzed. Similarly, use of different sensor material and subjecting them to different operating conditions, enhances the quality of the sensor array and accuracy of detection.

1. We identify compounds from each other using a sensor that is sensitive to those compounds and has different sensitivity to those compounds under different operating conditions by taking multiple readings under different operating conditions.

2. We identify compounds from each other using an array of similar sensors sensitive to several compounds with different sensitivity to those compounds under different operating conditions by operating each element of the array at a different operating condition.

3. We distinguish a larger number of compounds from each other using an array of different sensors, or a mixed array of similar and different sensors, that are sensitive to some or all of those compounds and those sensitivities change as the operating condition of those sensor elements are changed, when we set the operating conditions of each sensor element differently.

4. Multiple measurements using self-heating sensors when applied voltage is modified for each measurement can be used to distinguish different compounds.

5. Multiple measurements using self-heating sensors when duration of applied voltage is modified for each measurement can be used to distinguish different compounds.

6. Successive measurements using self-heating sensors, when the temperature of the sensor as a result of voltage application changes, can be used to distinguish different compounds.
